(19) United States
(12) Patent Application Publication
(10) Pub. No.: US 2025/0227496 A1
(43) Pub. Date: Jul. 10, 2025

(54) TIMING-BASED CONTROL FOR RELAXED MEASUREMENT

(71) Applicant: Nokia Technologies Oy, Espoo (FI)

(72) Inventors: Halit Murat GÜRSU, Munich (DE); Nitin MANGALVEDHE, Naperville, IL (US); Rapeepat RATASUK, Naperville, IL (US)

(21) Appl. No.: 18/836,115

(22) PCT Filed: Feb. 15, 2022
(86) PCT No.: PCT/US2022/016387

§ 371 Date: Aug. 6, 2024

(51) Int. Cl. H04W 24/02; H04W 56/00; H04W 76/20

(52) U.S. Cl. CPC H04W 24/02; H04W 56/0015; H04W 76/20

(57) ABSTRACT

Disclosed is a method comprising comparing, by a terminal device in a radio access network, a change in reference timing with a threshold value; and 5 applying or stopping, by the terminal device, relaxed measurement on one or more cells of the radio access network based at least partly on the comparison.

### FIELD

The following exemplary embodiments relate to wireless communication.

### BACKGROUND

Relaxed measurement may be used to enable a terminal device to perform mobility-related measurements less frequently, for example. However, incorrect activation of relaxed measurement may lead to cell re-selection delay, or radio link or beam failure. Thus, it is desirable to avoid incorrect activations of relaxed measurement.

### SUMMARY

The scope of protection sought for various exemplary embodiments is set out by the claims. The exemplary embodiments and features, if any, described in this specification that do not fall under the scope of the claims are to be interpreted as examples useful for understanding various exemplary embodiments.

According to an aspect, there is provided an apparatus in a radio access network, the apparatus comprising at least one processor, and at least one memory including computer program code, wherein the at least one memory and the computer program code are configured, with the at least one processor, to cause the apparatus to: compare a change in reference timing with a threshold value; and apply or stop relaxed measurement on one or more cells of the radio access network based at least partly on the comparison.

According to another aspect, there is provided an apparatus in a radio access network, the apparatus comprising means for: comparing a change in reference timing with a threshold value; and applying or stopping relaxed measurement on one or more cells of the radio access network based at least partly on the comparison.

According to another aspect, there is provided a method comprising: comparing, by a terminal device in a radio access network, a change in reference timing with a threshold value; and applying or stopping, by the terminal device, relaxed measurement on one or more cells of the radio access network based at least partly on the comparison.

According to another aspect, there is provided a computer program product comprising program instructions which, when run on a computing apparatus in a radio access network, cause the computing apparatus to perform at least the following: comparing a change in reference timing with a threshold value; and applying or stopping relaxed measurement on one or more cells of the radio access network based at least partly on the comparison.

According to another aspect, there is provided a computer program comprising instructions for causing an apparatus in a radio access network to perform at least the following: comparing a change in reference timing with a threshold value; and applying or stopping relaxed measurement on one or more cells of the radio access network based at least partly on the comparison.

According to another aspect, there is provided a computer readable medium comprising program instructions for causing an apparatus in a radio access network to perform at least the following: comparing a change in reference timing with a threshold value; and applying or stopping relaxed measurement on one or more cells of the radio access network based at least partly on the comparison.

According to another aspect, there is provided a non-transitory computer readable medium comprising program instructions for causing an apparatus in a radio access network to perform at least the following: comparing a change in reference timing with a threshold value; and applying or stopping relaxed measurement on one or more cells of the radio access network based at least partly on the comparison.

According to another aspect, there is provided an apparatus in a radio access network, the apparatus comprising at least one processor, and at least one memory including computer program code, wherein the at least one memory and the computer program code are configured, with the at least one processor, to cause the apparatus to: receive, from a network element in the radio access network, a command for stopping relaxed measurement on one or more cells of the radio access network, wherein the command is transmitted from the network element based at least partly on a comparison of a change in reference timing with a threshold value; and stop the relaxed measurement on the one or more cells in response to receiving the command.

According to another aspect, there is provided an apparatus in a radio access network, the apparatus comprising means for: receiving, from a network element in the radio access network, a command for stopping relaxed measurement on one or more cells of the radio access network, wherein the command is transmitted from the network element based at least partly on a comparison of a change in reference timing with a threshold value; and stopping the relaxed measurement on the one or more cells in response to receiving the command.

According to another aspect, there is provided a method comprising: receiving, by a terminal device in a radio access network, from a network element in the radio access network, a command for stopping relaxed measurement on one or more cells of the radio access network, wherein the command is transmitted from the network element based at least partly on a comparison of a change in reference timing with a threshold value; and stopping, by the terminal device, the relaxed measurement on the one or more cells in response to receiving the command.

According to another aspect, there is provided a computer program comprising instructions for causing an apparatus in a radio access network to perform at least the following: receiving, from a network element in the radio access network, a command for stopping relaxed measurement on one or more cells of the radio access network, wherein the command is transmitted from the network element based at least partly on a comparison of a change in reference timing with a threshold value; and stopping the relaxed measurement on the one or more cells in response to receiving the command.

According to another aspect, there is provided a computer program product comprising program instructions which, when run on a computing apparatus in a radio access network, cause the computing apparatus to perform at least the following: receiving, from a network element in the radio access network, a command for stopping relaxed measurement on one or more cells of the radio access network, wherein the command is transmitted from the network element based at least partly on a comparison of a change in reference timing with a threshold value; and stopping the relaxed measurement on the one or more cells in response to receiving the command.

According to another aspect, there is provided a computer readable medium comprising program instructions for causing an apparatus in a radio access network to perform at least the following: receiving, from a network element in the radio access network, a command for stopping relaxed measurement on one or more cells of the radio access network, wherein the command is transmitted from the network element based at least partly on a comparison of a change in reference timing with a threshold value; and stopping the relaxed measurement on the one or more cells in response to receiving the command.

According to another aspect, there is provided a non-transitory computer readable medium comprising program instructions for causing an apparatus in a radio access network to perform at least the following: receiving, from a network element in the radio access network, a command for stopping relaxed measurement on one or more cells of the radio access network, wherein the command is transmitted from the network element based at least partly on a comparison of a change in reference timing with a threshold value; and stopping the relaxed measurement on the one or more cells in response to receiving the command.

According to another aspect, there is provided an apparatus in a radio access network, the apparatus comprising at least one processor, and at least one memory including computer program code, wherein the at least one memory and the computer program code are configured, with the at least one processor, to cause the apparatus to: indicate, to a terminal device in the radio access network, a threshold value, wherein the threshold value is to be compared with a change in reference timing associated with the terminal device for determining whether the terminal device is to apply or stop relaxed measurement on one or more cells of the radio access network.

According to another aspect, there is provided an apparatus in a radio access network, the apparatus comprising means for: indicating, to a terminal device in the radio access network, a threshold value, wherein the threshold value is to be compared with a change in reference timing associated with the terminal device for determining whether the terminal device is to apply or stop relaxed measurement on one or more cells of the radio access network.

According to another aspect, there is provided a method comprising: indicating, by a network element in a radio access network, to a terminal device in the radio access network, a threshold value, wherein the threshold value is to be compared with a change in reference timing associated with the terminal device for determining whether the terminal device is to apply or stop relaxed measurement on one or more cells of the radio access network.

According to another aspect, there is provided a computer program comprising instructions for causing an apparatus in a radio access network to perform at least the following: indicating, to a terminal device in the radio access network, a threshold value, wherein the threshold value is to be compared with a change in reference timing associated with the terminal device for determining whether the terminal device is to apply or stop relaxed measurement on one or more cells of the radio access network.

According to another aspect, there is provided a computer program product comprising program instructions which, when run on a computing apparatus in a radio access network, cause the computing apparatus to perform at least the following: indicating, to a terminal device in the radio access network, a threshold value, wherein the threshold value is to be compared with a change in reference timing associated with the terminal device for determining whether the terminal device is to apply or stop relaxed measurement on one or more cells of the radio access network.

According to another aspect, there is provided a computer readable medium comprising program instructions for causing an apparatus in a radio access network to perform at least the following: indicating, to a terminal device in the radio access network, a threshold value, wherein the threshold value is to be compared with a change in reference timing associated with the terminal device for determining whether the terminal device is to apply or stop relaxed measurement on one or more cells of the radio access network.

According to another aspect, there is provided a non-transitory computer readable medium comprising program instructions for causing an apparatus in a radio access network to perform at least the following: indicating, to a terminal device in the radio access network, a threshold value, wherein the threshold value is to be compared with a change in reference timing associated with the terminal device for determining whether the terminal device is to apply or stop relaxed measurement on one or more cells of the radio access network.

According to another aspect, there is provided an apparatus in a radio access network, the apparatus comprising at least one processor, and at least one memory including computer program code, wherein the at least one memory and the computer program code are configured, with the at least one processor, to cause the apparatus to: compare a change in reference timing with a threshold value, wherein the reference timing is associated with a terminal device in the radio access network; and transmit, to the terminal device, based at least partly on the comparison, a command indicating the terminal device to stop relaxed measurement on one or more cells of the radio access network.

According to another aspect, there is provided an apparatus in a radio access network, the apparatus comprising means for: comparing a change in reference timing with a threshold value, wherein the reference timing is associated with a terminal device in the radio access network; and transmitting, to the terminal device, based at least partly on the comparison, a command indicating the terminal device to stop relaxed measurement on one or more cells of the radio access network.

According to another aspect, there is provided a method comprising: comparing, by a network element in a radio access network, a change in reference timing with a threshold value, wherein the reference timing is associated with a terminal device in the radio access network; and transmitting, to the terminal device, based at least partly on the comparison, a command indicating the terminal device to stop relaxed measurement on one or more cells of the radio access network.

According to another aspect, there is provided a computer program comprising instructions for causing an apparatus in a radio access network to perform at least the following: comparing a change in reference timing with a threshold value, wherein the reference timing is associated with a terminal device in the radio access network; and transmitting, to the terminal device, based at least partly on the comparison, a command indicating the terminal device to stop relaxed measurement on one or more cells of the radio access network.

According to another aspect, there is provided a computer program product comprising program instructions which, when run on a computing apparatus in a radio access network, cause the computing apparatus to perform at least the following: comparing a change in reference timing with a threshold value, wherein the reference timing is associated with a terminal device in the radio access network; and transmitting, to the terminal device, based at least partly on the comparison, a command indicating the terminal device to stop relaxed measurement on one or more cells of the radio access network.

According to another aspect, there is provided a computer readable medium comprising program instructions for causing an apparatus in a radio access network to perform at least the following: comparing a change in reference timing with a threshold value, wherein the reference timing is associated with a terminal device in the radio access network; and transmitting, to the terminal device, based at least partly on the comparison, a command indicating the terminal device to stop relaxed measurement on one or more cells of the radio access network.

According to another aspect, there is provided a non-transitory computer readable medium comprising program instructions for causing an apparatus in a radio access network to perform at least the following: comparing a change in reference timing with a threshold value, wherein the reference timing is associated with a terminal device in the radio access network; and transmitting, to the terminal device, based at least partly on the comparison, a command indicating the terminal device to stop relaxed measurement on one or more cells of the radio access network.

According to another aspect, there is provided a system comprising at least a terminal device and a network element in a radio access network. The network element is configured to: indicate a threshold value to the terminal device. The terminal device is configured to: compare a change in reference timing with the threshold value; and apply or stop relaxed measurement on one or more cells of the radio access network based at least partly on the comparison.

According to another aspect, there is provided a system comprising at least a terminal device and a network element in a radio access network. The network element comprises means for: indicating a threshold value to the terminal device. The terminal device comprises means for: comparing a change in reference timing with the threshold value; and applying or stopping relaxed measurement on one or more cells of the radio access network based at least partly on the comparison.

According to another aspect, there is provided a system comprising at least a terminal device and a network element in a radio access network. The network element is configured to: compare a change in reference timing with a threshold value, wherein the reference timing is associated with the terminal device; and transmit, to the terminal device, based at least partly on the comparison, a command indicating the terminal device to stop relaxed measurement on one or more cells of the radio access network. The terminal device is configured to: stop the relaxed measurement on the one or more cells in response to receiving the command.

According to another aspect, there is provided a system comprising at least a terminal device and a network element in a radio access network. The network element comprises means for: comparing a change in reference timing with a threshold value, wherein the reference timing is associated with the terminal device; and transmitting, to the terminal device, based at least partly on the comparison, a command indicating the terminal device to stop relaxed measurement on one or more cells of the radio access network. The terminal device comprises means for: stopping the relaxed measurement on the one or more cells in response to receiving the command.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates a system to which some exemplary embodiments may be applied;

FIG. 3 illustrates a signaling diagram according to an exemplary embodiment;

FIG. 4 illustrates a signaling diagram according to an exemplary embodiment;

FIG. 5 illustrates a signaling diagram according to an exemplary embodiment;

FIG. 6 illustrates a flow chart according to an exemplary embodiment;

FIG. 7 illustrates a flow chart according to an exemplary embodiment;

FIG. 8 illustrates a flow chart according to an exemplary embodiment;

FIG. 9 illustrates a flow chart according to an exemplary embodiment;

FIG. 10 illustrates a flow chart according to an exemplary embodiment;

FIG. 11 illustrates an apparatus according to an exemplary embodiment;

FIG. 12 illustrates an apparatus according to an exemplary embodiment.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A), new radio (NR, 5G), or beyond 5G, without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

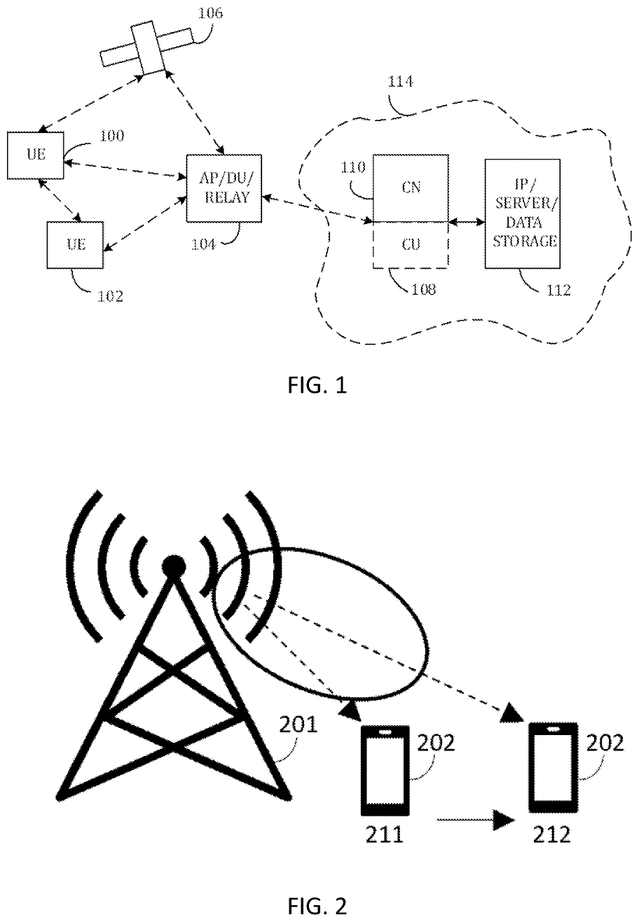

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g) NodeB) 104 providing the cell. The physical link from a user device to an eNodeB or a gNodeB, herein collectively referred to as (e/g) NodeB may be called uplink or reverse link, and the physical link from the (e/g) NodeB to the user device may be called downlink or forward link. It should be appreciated that (e/g) NodeBs or their functionalities may be implemented by using any node, host, server or access point etc. entity suitable for such a usage.

A communication system may comprise more than one (e/g) NodeB, in which case the (e/g) NodeBs may also be configured to communicate with one another over links, wired or wireless, designed for the purpose. These links may be used for signaling purposes. The (e/g) NodeB may be a computing device configured to control the radio resources of communication system it is coupled to. The (e/g) NodeB may also be referred to as a base station, an access point or any other type of interfacing device including a relay station capable of operating in a wireless environment. The (e/g) NodeB may include or be coupled to transceivers. From the transceivers of the (e/g) NodeB, a connection may be provided to an antenna unit that establishes bi-directional radio links to user devices. The antenna unit may comprise a plurality of antennas or antenna elements. The (e/g) NodeB may further be connected to core network 110 (CN or next generation core NGC). Depending on the system, the counterpart on the CN side may be a serving gateway (S-GW, routing and forwarding user data packets), packet data network gateway (P-GW) for providing connectivity of user devices (UEs) to external packet data networks, mobility management entity (MME), access and mobility management function (AMF), or location management function (LMF), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s), and/or between the IAB node and other IAB nodes (multi-hop scenario).

Another example of such a relay node may be a layer 1 relay called a repeater. The repeater may amplify a signal received from a base station and forward it to a UE, and/or amplify a signal received from the UE and forward it to the base station.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may also comprise other apparatuses, such as physical layer relay nodes or other network elements, etc. At least one of the (e/g) NodeBs may be a Home (e/g) nodeB.

Furthermore, the (e/g) nodeB or base station may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g) nodeB or base station. The DU may be defined as a logical node hosting radio link control (RLC), medium access control (MAC) and/or physical (PHY) layers of the (e/g) nodeB or base station. The operation of the DU may be at least partly controlled by the CU. The CU may comprise a control plane (CU-CP), which may be defined as a logical node hosting the RRC and the control plane part of the PDCP protocol of the CU for the (e/g) nodeB or base station. The CU may further comprise a user plane (CU-UP), which may be defined as a logical node hosting the user plane part of the PDCP protocol and the SDAP protocol of the CU for the (e/g) nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. In multilayer networks, one access node may provide one kind of a cell or cells, and thus a plurality of (e/g) NodeBs may be needed to provide such a network structure.

For fulfilling the need for improving the deployment and performance of communication systems, the concept of “plug-and-play” (e/g) NodeBs may be introduced. A network which may be able to use “plug-and-play” (e/g) NodeBs, may include, in addition to Home (e/g) NodeBs (H (e/g) nodeBs), a home node B gateway, or HNB-GW (not shown in FIG. 1). A HNB Gateway (HNB-GW), which may be installed within an operator's network, may aggregate traffic from a large number of HNBs back to a core network.

5G is designed to address a wide range of use cases, such as the enhanced mobile broadband (eMBB), ultra-reliable low latency communication (URLLC), and massive machine-type communication (mMTC), with different requirements in terms of data rates, latency, reliability, coverage, energy efficiency, and connection density. mMTC may cover cellular low power wide area (LPWA) technologies such as narrowband internet of things (NB-IoT) and long term evolution for machine type communication (LTE-MTC). Yet another use case for 5G is time-sensitive communication (TSC). However, in between these use cases, there are also some mid-range use cases, such as industrial wireless sensor networks, video surveillance, and wearables (e.g., smart watches, rings, eHealth-related devices, personal protection equipment, medical monitoring devices, etc.). In other words, the requirements of these mid-range use cases may be higher than LPWA, but lower than eMBB and URLLC. In order to efficiently serve these mid-range use cases, the 3rd generation partnership project (3GPP) has introduced reduced capability (RedCap) devices in NR Release 17 (Rel-17). RedCap devices may also be referred to as RedCap UEs, NR-Lite devices, or NR-Light devices.

RedCap devices may have lower complexity (e.g., reduced bandwidth and number of antennas), a longer battery life, and a smaller form factor than non-RedCap devices, such as eMBB UEs, URLLC UEs and other legacy UEs. For example, a RedCap device may comprise 1 receiver branch and 1 transmitter branch (1Rx/1Tx), or 2 receiver branches and 1 transmitter branch (2Rx/1Tx), in both frequency range 1 (FR1) and frequency range 2 (FR2). RedCap devices may support all FR1 and FR2 bands for frequency-division duplexing (FDD) and time-division duplexing (TDD).

Industrial wireless sensors and actuators are one example of RedCap devices. It may be desirable to connect these sensors and actuators to 5G radio access and core networks in order to improve flexibility, enhance productivity and efficiency, and improve operational safety. Industrial wireless sensors may comprise, for example, pressure sensors, humidity sensors, thermometers, motion sensors, and/or accelerometers, etc. Industrial wireless sensor network use cases include not only URLLC services with very high requirements, but also relatively low-end services requiring small device form factors and/or being completely wireless with a battery life of several years. These low-end services may be provided by RedCap devices. Industrial wireless sensors associated with low-end services may also have the following use-case-specific requirements: communication service availability is at least 99.99%, end-to-end latency is less than 100 ms, and the reference bit rate is less than 2 Mbps (potentially asymmetric, e.g., UL heavy traffic) for all use cases and the device is expected to be mostly stationary. For safety-related sensors, the latency requirement may be more stringent, for example 5-10 ms.

Video surveillance cameras are another example of RedCap devices. The deployment of surveillance cameras may be beneficial, for example, for smart city use cases, as well as for factories and industries, in order to monitor and control city/factory resources more efficiently. The following requirements may apply for video surveillance use cases: the reference economic video bitrate is 2-4 Mbps, latency is less than 500 ms, and the reliability is at least 99%-99.9%. High-end video applications (e.g., for farming) may require a video bitrate of 7.5-25 Mbps. It is noted that the traffic pattern may be dominated by UL transmissions.

Wearables, such as smart watches, rings, eHealth-related devices, personal protection equipment, and/or medical monitoring devices, are another example of RedCap devices. One characteristic for this use case is that the device is small in size. The following requirements may apply for wearables: the reference bitrate for smart wearable applications may be 5-50 Mbps in downlink (DL) and 2-5 Mbps in uplink (UL), and the peak bit rate of the device may be higher, for example up to 150 Mbps for DL and up to 50 Mbps for UL. In addition, the battery of the wearable device should last multiple days (e.g., up to 1-2 weeks).

For example, UE energy consumption may be reduced by reducing the UE measurement frequency such that the measurements are performed less frequently. Optimizing energy consumption of UEs through reduced measurement frequency can be investigated in two branches. The first branch is mobility-related measurements, and the second branch is user plane-related measurements. Radio resource management (RRM) relaxation investigates the mobility-related measurements. RRM relaxation may also be referred to as relaxed monitoring or relaxed measurement. RRM relaxation comprises two components: RRM relaxation trigger, and RRM measurement relaxation.

The RRM relaxation trigger comprises one or more criteria, either configured to the UE or acquired by the UE from the serving cell, that are used to initiate RRM measurement relaxation. In NR Release 16 (R16), two RRM relaxation triggers, or criteria, have been specified for the UE: a low-mobility criterion, and a not-at-cell-edge criterion.

The low-mobility criterion aims to identify a UE in a low mobility state. In order for the low-mobility criterion to be fulfilled, the reference signal received power (RSRP) of the serving cell, denoted as RSRPrx, should meet the following condition within a time period of TSearchDeltaP:
(RSRPrxRef-RSRPrx)<RSRPSearchDeltaP,
   where RSRPrx is the current RSRP value of the serving gNB, and RSRPrxRef is a reference RSRP value that may be updated in three different ways. Firstly, RSRPrxRef may be updated to the RSRP value of the serving gNB after selecting or reselecting a new gNB. Secondly, RSRPrxRef may be updated to the new RSRP value, when the UE is moving closer to the cell center, i.e., (RSRPrx-RSRPrxRef)>0. Thirdly, if the relaxed measurement criterion has not been met for TSearchDeltaP, the UE may set the value of RSRPrxRef to the current RSRPrx value. RSRPSearchDeltaP is a parameter configured to the UE to monitor the received signal variation. The values of RSRPSearchDeltaP and TSearchDeltaP can be used to define the mobility level of the UE.

The not-at-cell-edge criterion aims to detect if the UE is not at the cell edge of the serving cell. In order to detect whether the UE is at the cell edge or not, the UE may compare the received signal level against a threshold as follows:
RSRPrx>RSRPSearchThresholdP,
   where RSRPrx is the current RSRP value of the serving gNB, and RSRPSearch ThresholdP is the RSRP threshold set for the not-at-cell-edge criterion. The not-at-cell-edge criterion is fulfilled, when RSRPrx is above the threshold RSRPSearch ThresholdP (i.e., the UE is not at the cell edge).

A given UE may be configured to monitor at least one of the RRM relaxation triggers. The network may configure the at least one trigger (i.e., either the low-mobility criterion or the not-at-cell-edge criterion, or both) to the UE independently. In case the RRM relaxation is triggered with respect to its configuration, the UE may apply RRM measurement relaxation.

There are multiple ways to relax the RRM measurements, such as the cell to relax (e.g., whether to relax the serving cell or a neighbour cell), and how frequently to measure the relaxed cell (i.e., the measurement periodicity for the relaxed cell). In other words, in case the RRM relaxation is triggered, the UE may adjust the measurement periodicity for the serving cell and/or a neighbour cell in order to perform the RRM measurements less frequently. Relaxed measurements with longer intervals (scaling factor) can be configured. For example, the UE may stop the RRM measurements for up to 1 hour upon triggering the RRM relaxation.

RRM relaxation works when the UE detects a serving cell RSRP change as explained above. However, in frequency range 2 (FR2), which includes frequency bands from 24.25 GHz to 52.6 GHz, directive beamforming gain may work in sustaining the RSRP level over tens of meters. That is, although the path loss increases as the UE moves away from the cell site, the antenna gain also increases due to the antenna beam shape, and thus the RSRP level may remain practically unchanged. This is illustrated in FIG. 2.

FIG. 2 illustrates a system, to which some exemplary embodiments may be applied. The system comprises a gNB 201 and a UE 202. When the UE 202 moves from a first position 211 to a second position 212, the path loss increases, but the antenna beamforming gain also increases. Thus, the cell RSRP does not decay with distance, when the UE 202 moves from the first position 211 to the second position 212.

However, if the RSRP values do not change (or they change very little) between the first position 211 and the second position 212, then the RRM relaxation may detect that the UE 202 is stationary, even though it is actually moving. This may lead to an incorrect RRM relaxation activation, as well as cell re-selection delay in RRC idle or inactive state, or radio link failure or beam failure in RRC connected state.

Some exemplary embodiments may address the above issue by enhancing the RRM relaxation procedure with the use of downlink and/or uplink propagation delay related timing information to use as an additional RRM relaxation criterion. This may increase the UE power efficiency and idle mobility performance. Some exemplary embodiments may be used, for example, in FR2 or FR1.

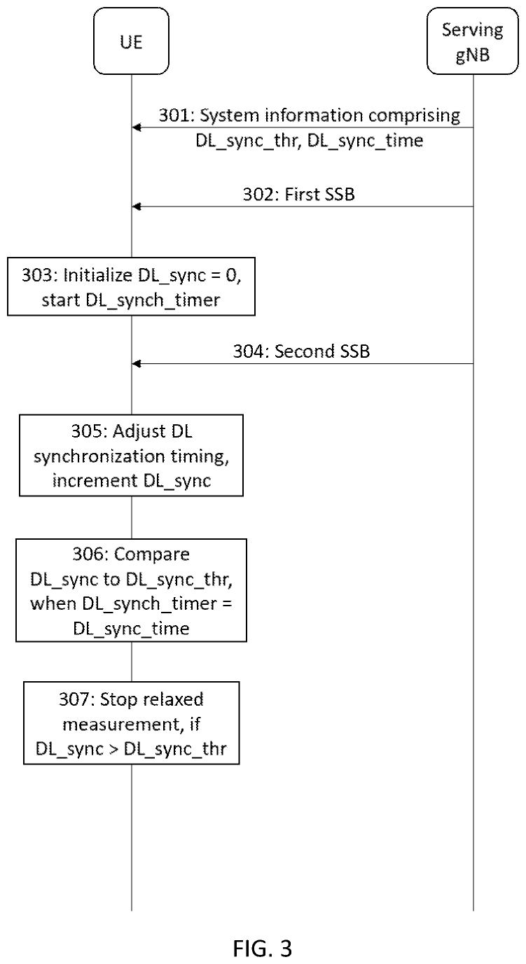

FIG. 3 illustrates a signaling diagram according to an exemplary embodiment. This exemplary embodiment may be used for a UE in any RRC state. For example, the UE may be in RRC idle state, RRC inactive state, or RRC connected state. In this exemplary embodiment, the network may configure the UE with a threshold value related to a change in reference timing, such as DL synchronization timing (e.g., radio frame or symbol timing). Herein a symbol may refer to an orthogonal frequency-division multiplexing (OFDM) symbol. The UE may monitor the change in the DL synchronization timing through synchronization signals or other reference signals. The UE may use the threshold value and its synchronization measurements to determine whether the relaxed measurement (RRM relaxation) should be initiated. The change in the DL synchronization timing may correspond to a change in DL propagation delay compensation. In other words, the DL propagation delay compensation may be changed by changing the DL synchronization timing.

Referring to FIG. 3, in step 301, a network element such as a gNB transmits, or broadcasts, system information comprising DL synchronization based RRM relaxation parameters. The gNB may be the serving gNB providing the serving cell of the UE. The UE may be, for example, a reduced capability (RedCap) device or any other type of UE. The UE may be configured to operate in FR2. The gNB and the UE may be in a radio access network.

The DL synchronization based RRM relaxation parameters may comprise a DL synchronization threshold (DL_sync_thr), and a DL synchronization time (DL_sync_time). DL_sync_time defines a time interval for a timer denoted as DL_synch_timer. DL_sync_thr is a threshold configured by the network to stop the relaxed measurement (RRM relaxation). As a non-limiting example, the time value of DL_sync_thr may be 1 μs, and the time value of DL_sync_time may be 100 ms. However, it should be noted other values may also be used.

The DL synchronization is a procedure, in which the UE detects the radio frame boundary (i.e, the exact timing when a radio frame starts) and OFDM symbol boundary (i.e., the exact timing when an OFDM symbol starts). The DL synchronization may also be referred to as time synchronization. The DL synchronization may be done by detecting and analyzing a synchronization signal such as synchronization signal block (SSB), or a reference signal such as phase-tracking reference signal (PTRS), channel state information reference signal (CSI-RS), or common reference signal (CRS). The DL synchronization timing refers to the timing obtained from the DL synchronization procedure (time synchronization procedure).

In step 302, the gNB transmits, or broadcasts, a first SSB. The UE receives the first SSB. The first SSB comprises a primary synchronization signal (PSS), a secondary synchronization signal (SSS), and a physical broadcast channel (PBCH).

In step 303, the UE adjusts the DL synchronization timing based on the reception timing of the first SSB (e.g., in comparison to or based on the UE's own internal clock), and the UE initializes the DL_sync parameter by setting an initial value such as zero for the DL_sync parameter. The value of DL_sync indicates the cumulative DL synchronization timing adjustments, or changes, that the UE has performed. The initialization of the DL_sync parameter may be triggered, or caused, by at least one of: reception of the RRM relaxation parameters (e.g., DL_sync_thr and/or DL_sync_time), initiation of relaxed measurement, stopping of relaxed measurement, and/or changing of a beam. If no relaxed measurement (RRM relaxation) is started, the DL_sync parameter may be initialized upon reception of new RRM relaxation parameters. The DL_sync parameter may be reset (re-initialized to the initial value) after the time interval indicated by DL_sync_time. A sliding time window may be used to take into account the DL sync change within a time window, and this window may be slided to consider the latest DL sync changes within this time window after each time step. Upon initializing the DL_sync parameter, the UE starts a downlink synchronization timer (DL_synch_timer), which is configured to expire when the value of DL_sync_time (received in step 301) is reached.

In step 304, the gNB transmits, or broadcasts, a second SSB. The UE receives the second SSB. The second SSB comprises a PSS, an SSS, and a PBCH. Herein the terms “first SSB” and “second SSB” are used to distinguish the SSBs, and they do not necessarily mean specific indices of the SSBs.

The UE may move in the cell provided by the gNB and monitor the RRM relaxation threshold for RSRP. As the UE is moving, the RSRP may stay substantially the same due to beamforming. Thus, the UE may not observe any significant change in the RSRP, and the UE may determine that it is in a stationary state with respect to the low-mobility RRM relaxation criterion (even though the UE is actually moving in the cell). If there would be no synchronization-related RRM relaxation criteria, the UE would have stopped doing some measurements. However, in this exemplary embodiment, the UE evaluates the synchronization criteria as additional RRM relaxation criteria.

In step 305, the UE adjusts the DL synchronization based on the reception timing of the second SSB, and increments the initial value of DL_sync by an amount corresponding to the adjustment.

The gNB may also transmit, or broadcast, one or more subsequent SSBs in addition to the first SSB and the second SSB. The UE may adjust the DL synchronization timing based on the reception timing of each subsequent SSB that it receives, and increment the value of DL_sync with each subsequent SSB that it receives. In other words, the UE may increment the value of the DL_sync parameter based on one or more adjustments made by the UE to the DL synchronization timing.

For example, the UE may accumulate each DL synchronization timing adjustment in the DL_sync parameter by setting DL_sync=DL_sync+δ_{dl} during DL_sync_time, where δ_{dl} is the DL synchronization timing adjustment that the UE may perform based on a given SSB measurement. The SSB measurement periodicity may be related to the UE power saving settings or complying with serving cell measurement relaxation.

In step 306, the UE compares the incremented value of the DL_sync parameter to the threshold value DL_sync_thr upon expiration of the DL_synch_timer. The DL_synch_timer expires upon reaching the value of DL_sync_time (received in step 301).

As one example, the UE may determine, based on the comparison, that the threshold value DL_sync_thr is exceeded:
DL_sync>DL_sync_thr

As another example, the UE may determine, based on the comparison, that the threshold value DL_sync_thr is exceeded by also taking into account the local oscillator drift:

$$DL\_sync - \frac{{Drift}_{1} + {Drift}_{2}}{1 {0}^{6}} .$$

### DL_sync_time>DL_sync_thr

where Drift₁ is the local oscillator drift of the gNB. The drift refers to an unintended offset from the nominal frequency of the local oscillator. For example, the current specifications define that the gNB shall be accurate over 1 ms, wherein Drift₁ may be ±0.05 ppm for a wide-area gNB, or ±0.1 ppm for a medium-range gNB, or ±0.1 ppm for a local-area gNB. 1 ppm (part per million) means a 1/10⁶ part of the nominal frequency of the local oscillator.

Drift₂ is the local oscillator drift of the UE. For example, Drift₂ may be approximately 100 ppm for a RedCap UE, or 10 or less for a high-end UE such as an eMBB UE or a URLLC UE.

The second term, i.e.,

$$\frac{{Drift}_{1} + {Drift}_{2}}{1 {0}^{6}} ,$$

on the left-hand side of the above equation represents the worst-case timing drift due to the local oscillator imperfections at the gNB and the UE. For example, these worst-case timing drifts may correspond to standard-specified requirements for the gNB and the UE.

In step 307, based at least partly on the comparison, the UE determines to not initiate relaxed measurement (RRM relaxation), or to stop an ongoing RRM relaxation on one or more cells in the radio access network, in response to the incremented value of DL_sync (which corresponds the change in DL synchronization timing due to the adjustments) exceeding the threshold value of DL_sync_thr (e.g., DL_sync>DL_sync_thr). In other words, if the threshold value DL_sync_thr is exceeded, the UE determines that there has been a false stationary detection (i.e., the UE incorrectly determined that it was in a stationary state due to the unchanged RSRP, even though the UE was actually moving). Thus, the UE determines to not initiate RRM relaxation, or to stop an ongoing RRM relaxation, since the synchronization criteria is not fulfilled.

Alternatively, if the incremented value of DL_sync is less than or equal to the threshold value DL_sync_thr, the UE may determine that there has been a correct stationary detection. In this case, the UE may apply or initiate the relaxed measurement (RRM relaxation) and continue monitoring the DL synchronization timing. For example, upon initiating the relaxed measurement (RRM relaxation), the UE may measure the SSBs from the serving cell and/or a neighbour cell less frequently (i.e., the UE may skip measuring some SSBs by using a longer time interval for the measurements). In case the UE relaxes the serving cell measurements, the UE may periodically do multiple more frequent measurements to validate the synchronization validity.

In other words, both the legacy RRM relaxation criteria (e.g., the low-mobility criterion and the not-at-cell-edge criterion) and the synchronization criteria need to be fulfilled in order for the UE to initiate the relaxed measurement (RRM relaxation). The synchronization criteria may be fulfilled, if the value of DL_sync (with or without local oscillator drift) is less than or equal to the DL synchronization threshold DL_sync_thr upon expiration of the DL_synch_timer.

It should be noted that the above exemplary embodiment is not limited to SSB. Any other DL reference signal or synchronization signal may alternatively be used instead of SSB.

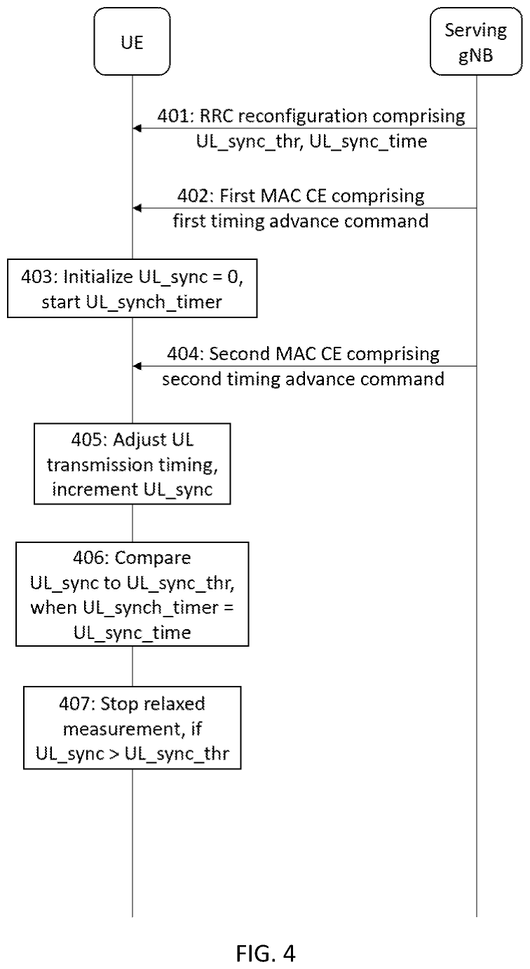

FIG. 4 illustrates a signaling diagram according to another exemplary embodiment. This exemplary embodiment may be used for a UE in RRC connected state. In this exemplary embodiment, the network may configure the UE with a threshold value for a change in reference timing, such as UL transmission timing (e.g., radio frame or OFDM symbol timing). The network may provide continuous UL synchronization updates to the UE via timing advance commands. The UE may monitor the UL transmission timing change against the threshold value to determine whether the relaxed measurement (RRM relaxation) should be initiated. The change in the UL transmission timing may correspond to a change in UL propagation delay compensation. In other words, the UL propagation delay compensation may be changed by changing the UL transmission timing.

Referring to FIG. 4, in step 401, a network element such as a gNB transmits, to the UE, an RRC reconfiguration message comprising UL synchronization based RRM relaxation parameters. The UE receives the RRC reconfiguration message. In other words, the UE obtains the UL synchronization based RRM relaxation parameters via dedicated signaling from the gNB. The gNB may be the serving gNB providing the serving cell of the UE. The UE may be, for example, a reduced capability (RedCap) device or any other type of UE. The UE may be configured to operate in FR2. The gNB and the UE may be in a radio access network.

The UL synchronization based RRM relaxation parameters may comprise an UL synchronization threshold (UL_sync_thr), and an UL synchronization time (UL_sync_time). UL_sync_time defines a time interval for a timer denoted as UL_synch_timer. UL_sync_thr is a threshold configured by the network to stop the RRM relaxation. As a non-limiting example, the time value of UL_sync_thr may be 1 μs, and the time value of UL_sync_time may be 100 ms. However, it should be noted other values may also be used.

The UL synchronization is a procedure, in which the UE determines the exact timing when it should transmit uplink data, such as physical uplink shared channel (PUSCH) and/or physical uplink control channel (PUCCH). The UL synchronization may also be referred to as time alignment. The gNB may be serving multiple UEs, and thus the gNB needs to ensure that the uplink signal from each UE is aligned with a common receiver timer of the gNB. Thus, the gNB may need to adjust the UL transmission timing of each UE via a timing advance command transmitted for example in a MAC control element (CE). Once the UE has been assigned a timing advance value via the timing advance command, the UE may track its DL timing and adjust the UL transmission timing to be within a set threshold. The UL transmission timing refers to the timing obtained from the UL synchronization procedure (time alignment procedure).

The timing advance may be used to take into account the propagation delay between the UE and the gNB. The timing advance is a negative offset, at the UE, between the start of a received downlink radio frame and a transmitted uplink radio frame. This offset may be used to ensure that the DL and UL radio frames are synchronized at the gNB in the time domain.

In step 402, the gNB transmits a first MAC CE to the UE, in case the UE's UL transmission timing changes. The UE receives the first MAC CE. The first MAC CE comprises a first timing advance command.

In step 403, the UE adjusts the UL transmission timing based on the first timing advance command, and the UE initializes the UL_sync parameter by setting an initial value such as zero for the UL_sync parameter. The value of UL_sync indicates the cumulative UL transmission timing adjustments, or changes, that the UE has performed. The initialization of the UL_sync parameter may be triggered, or caused, by at least one of: reception of the RRM relaxation parameters (e.g., the threshold value), initiation of relaxed measurement, stopping of relaxed measurement, and/or changing of a beam. If no relaxed measurement (RRM relaxation) is started, the UL_sync parameter may be initialized upon reception of new RRM relaxation parameters. The UL_sync parameter may be reset (re-initialized to the initial value) after the time interval indicated by UL_sync_time. A sliding time window may be used to take into account the UL sync change within a time window, and this window may be slided to consider the latest UL sync changes within this time window after each time step. Upon initializing the UL_sync parameter, the UE starts an uplink synchronization timer (UL_synch_timer), which is configured to expire when the value of UL_sync_time (received in step 401) is reached.

In step 404, the gNB transmits a second MAC CE to the UE. The UE receives the second MAC CE. The second MAC CE comprises a second timing advance command.

The UE may move in the cell provided by the gNB and monitor the RRM relaxation threshold for RSRP. As the UE is moving, the RSRP may stay substantially the same due to beamforming. Thus, the UE may not observe any significant change in RSRP, and the UE may determine that it is in a stationary state with respect to the low-mobility RRM relaxation criterion (even though the UE is actually moving in the cell). If there would be no synchronization-related RRM relaxation criteria, the UE would have stopped doing some measurements. However, in this exemplary embodiment, the UE evaluates the synchronization criteria as additional RRM relaxation criteria.

In step 405, the UE adjusts the UL transmission timing based on the second timing advance command, and increments the initial value of UL_sync by an amount corresponding to the adjustment.

The gNB may also transmit one or more subsequent timing advance commands to the UE in addition to the first timing advance command and the second timing advance command. The UE may adjust the UL transmission timing based on each subsequent timing advance command that it receives, and increment the value of UL_sync with each subsequent timing advance command that it receives. In other words, the UE may increment the value of the UL_sync parameter based on one or more adjustments made by the UE to the UL transmission timing.

For example, the UE may accumulate each UL transmission timing adjustment in the UL_sync parameter by setting UL_sync=UL_sync+TA during UL_sync_time, where TA is the value of the timing advance adjustment performed by the UE based on a given timing advance command.

In step 406, the UE compares the incremented value of the UL_sync parameter to the threshold value UL_sync_thr upon expiration of the UL_synch_timer. The UL_synch_timer expires upon reaching the value of UL_sync_time (received in step 401).

As one example, the UE may determine, based on the comparison, that the threshold value UL_sync_thr is exceeded:
UL_sync>UL_sync_thr

It should be noted that the local oscillator drift is not considered for the UL synchronization, as the drift difference between the UE and the gNB may be a concern only during the calculation and the transmission of the timing advance command from the gNB to the UE after receiving a message from the UE at the gNB side.

In step 407, based at least partly on the comparison, the UE determines to not initiate relaxed measurement (RRM relaxation), or to stop an ongoing RRM relaxation on one or more cells in the radio access network, in response to the value of UL_sync (which corresponds to the change in UL transmission timing due to the adjustments) exceeding the threshold value of UL_sync_thr (e.g., UL_sync>UL_sync_thr). In other words, if the value of UL_sync is greater than UL_sync_thr, the UE determines that there has been a false stationary detection (i.e., the UE incorrectly determined that it was in a stationary state due to the unchanged RSRP, even though the UE was actually moving). Thus, the UE determines to not initiate RRM relaxation, or to stop an ongoing RRM relaxation, since the synchronization criteria is not fulfilled.

Alternatively, if the incremented value of UL_sync is less than or equal to the UL_sync_thr, the UE determines that there has been a correct stationary detection. In this case, the UE may apply or initiate the RRM relaxation and continue monitoring the UL synchronization.

In other words, both the legacy RRM relaxation criteria (e.g., the low-mobility criterion and the not-at-cell-edge criterion) and the synchronization criteria need to be fulfilled in order for the UE to initiate RRM relaxation. The synchronization criteria may be fulfilled, if the value of UL_sync is less than or equal to the UL transmission timing threshold UL_sync_thr upon expiration of the UL_synch_timer.

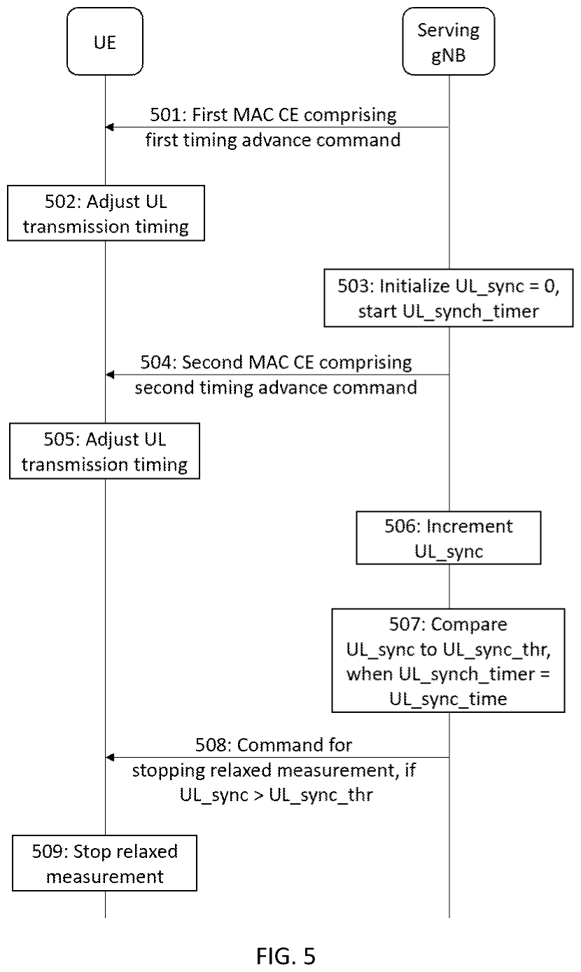

FIG. 5 illustrates a signaling diagram according to another exemplary embodiment. In this exemplary embodiment, the network may monitor the change in reference timing, such as UL transmission timing (e.g., radio frame or OFDM symbol timing) of a UE. The network may send a “stop RRM relaxation” command to the UE, when the change in the UL transmission timing of the UE exceeds a threshold value over a pre-defined time interval. The change in the UL transmission timing may correspond to a change in UL propagation delay compensation.

Referring to FIG. 5, in step 501, a network element such as a gNB transmits a first MAC CE to a UE, in case the UE's UL transmission timing changes. The UE receives the first MAC CE. The first MAC CE comprises a first timing advance command. The gNB may be the serving gNB providing the serving cell of the UE. The UE may be, for example, a reduced capability (RedCap) device or any other type of UE. The UE may be configured to operate in FR2. The gNB and the UE may be in a radio access network.

In step 502, the UE adjusts the UL transmission timing based on the first timing advance command.

In step 503, in response to transmitting the first timing advance command, the gNB initializes a parameter called UL_sync by setting an initial value such as zero for the UL_sync parameter. The value of UL_sync indicates the cumulative UL transmission timing adjustments, or changes, that the UE has performed. The initialization of the UL sync parameter may be triggered, or caused, by at least one of: initiation of relaxed RRM measurement at the UE, stopping of relaxed RRM measurement at the UE, and/or changing of a beam at the UE. The UL_sync parameter may be reset (re-initialized to the initial value) after the time interval indicated by UL_sync_time. A sliding time window may be used. Upon initializing the UL_sync parameter, the gNB starts an uplink synchronization timer (UL_synch_timer), which is configured to expire when a pre-defined value of a parameter called UL_sync_time is reached.

In step 504, the gNB transmits a second MAC CE to the UE. The UE receives the second MAC CE. The second MAC CE comprises a second timing advance command.

The UE may move in the cell provided by the gNB and monitor the RRM relaxation threshold for RSRP. As the UE is moving, the RSRP may stay substantially the same due to beamforming. Thus, the UE may not observe any significant change in RSRP, and the UE may determine that it is in a stationary state with respect to the low-mobility RRM relaxation criterion (even though the UE is actually moving in the cell). If there would be no synchronization-related RRM relaxation criteria, the UE would have stopped doing some measurements. However, in this exemplary embodiment, the gNB evaluates the synchronization criteria as additional RRM relaxation criteria.

In step 505, the UE adjusts the UL transmission timing based on the second timing advance command.

In step 506, the gNB increments the initial value of the UL_sync parameter by an amount corresponding to the change in the UL transmission timing made by the UE in step 505 based on the second timing advance command.

The gNB may also transmit one or more subsequent timing advance commands to the UE in addition to the first timing advance command and the second timing advance command. The UE may adjust the UL transmission timing based on each subsequent timing advance command that it receives, and the gNB may increment the value of UL_sync with each subsequent timing advance command that it transmits. In other words, the gNB may increment the value of the UL_sync parameter based on one or more adjustments made by the UE to the UL transmission timing.

For example, the gNB may accumulate each adjustment in the UL_sync parameter by setting UL_sync=UL_sync+TA for UL_sync_time, where TA is the value of the timing advance adjustment performed by the UE based on a given timing advance command.

In step 507, the gNB compares the incremented value of the UL_sync parameter to a pre-defined threshold value UL_sync_thr upon expiration of the UL_synch_timer. The UL_synch_timer expires upon reaching the pre-defined value of UL_sync_time.

As a non-limiting example, the time value of UL_sync_thr may be 1 μs, and the time value of UL_sync_time may be 100 ms. However, it should be noted other values may also be used.

In step 508, based at least partly on the comparison, the gNB transmits a command to the UE for stopping relaxed measurement (RRM relaxation) on one or more cells in the radio access network, in response to the value of UL_sync (which corresponds to the change in UL transmission timing due to the adjustments) exceeding the threshold value of UL_sync_thr (e.g., UL_sync>UL_sync_thr).

In step 509, the UE stops the relaxed measurement (RRM relaxation) on the one or more cells in the radio access network based on the command received in step 508.

Alternatively, if the value of UL_sync is less than or equal to the value of UL_sync_thr, then the gNB may transmit a command to the UE for initiating or continuing the RRM relaxation, and the UE may then initiate or continue to apply the RRM relaxation based on the received command.

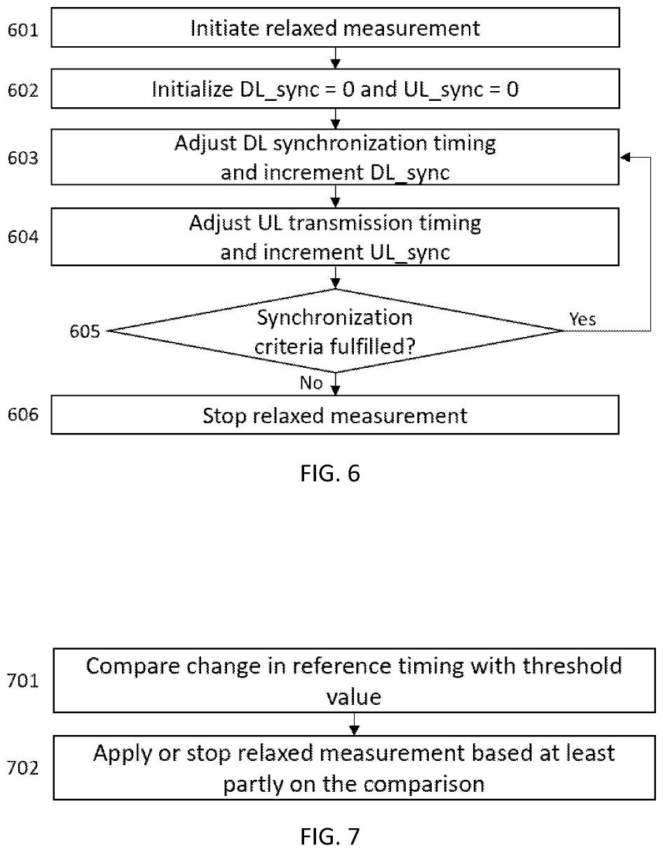

FIG. 6 illustrates a flow chart according to an exemplary embodiment. The steps illustrated in FIG. 6 may be performed by an apparatus such as, or comprised in, a terminal device in a radio access network. The terminal device may also be referred to as a user device, user equipment, or UE herein. The terminal device may be, for example, a reduced capability (RedCap) device or any other type of UE.

Referring to FIG. 6, in step 601, the UE applies or initiates relaxed measurement (RRM relaxation) on one or more cells in the radio access network using network-controlled criteria.

In step 602, the UE initializes the DL_sync and UL_sync parameters by setting the value of DL_sync as zero, and the value of UL_sync as zero.

In step 603, the UE adjusts DL synchronization timing upon receiving and decoding an SSB. The UE increments the value of DL_sync upon adjusting the DL synchronization timing.

For example, the UE may increment the value of DL_sync as follows:

$$DL\_sync ( t ) = DL\_sync ( t - 1 ) + {δ}_{dl}$$

where t is a time instant, and dat is a value corresponding to the DL synchronization timing adjustment.

In step 604, if the UE is in RRC connected state, the UE may adjust UL transmission timing based on a received timing advance command. The UE may increment the value of UL_sync upon adjusting the UL transmission timing.

In step 605, the UE determines whether the synchronization criteria are fulfilled. The synchronization criteria may be fulfilled, if the incremented value of DL_sync is less than or equal to the DL synchronization timing change threshold DL_sync_thr, and if the incremented value of UL_sync is less than or equal to the UL transmission timing change threshold UL_sync_thr.

In step 606, if the synchronization criteria are not fulfilled (605: no), then the UE stops relaxed measurement (RRM relaxation) on the one or more cells in the radio access network.

Otherwise, if the synchronization criteria are fulfilled (605: yes), then the process returns to step 603 after step 605 and continues from there, i.e., the UE adjusts the DL synchronization timing based on the next received SSB, and increments the value of DL_sync. In other words, the UE may perform steps 603-605 iteratively until it determines that the synchronization criteria are not fulfilled.

FIG. 7 illustrates a flow chart according to an exemplary embodiment. The steps illustrated in FIG. 7 may be performed by an apparatus such as, or comprised in, a terminal device in a radio access network. The terminal device may also be referred to as a user device, user equipment, or UE herein. For example, the apparatus may correspond to the UE of FIGS. 3-4.

Referring to FIG. 7, in step 701, a change in reference timing is compared with a threshold value.

In step 702, relaxed measurement is stopped or applied on one or more cells of the radio access network based at least partly on the comparison. For example, applying the relaxed measurement may refer to increasing the time interval of RRM measurements, i.e., performing the RRM measurements less frequently. As another example, stopping the relaxed measurement may refer to decreasing the time interval of RRM measurements, i.e., performing the RRM measurements more frequently (compared to when the relaxed measurement is applied).

The reference timing may be in connection with downlink synchronization timing or uplink transmission timing of the apparatus on the one or more cells.

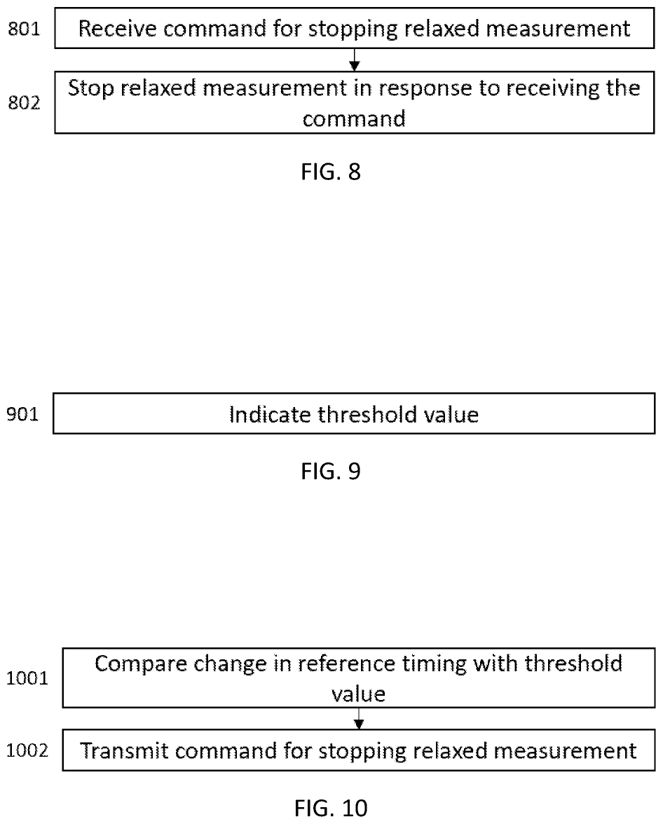

FIG. 8 illustrates a flow chart according to an exemplary embodiment. The steps illustrated in FIG. 8 may be performed by an apparatus such as, or comprised in, a terminal device in a radio access network. The terminal device may also be referred to as a user device, user equipment, or UE herein. For example, the apparatus may correspond to the UE of FIG. 5.

Referring to FIG. 8, in step 801, a command for stopping relaxed measurement on one or more cells of the radio access network is received from a network element in the radio access network, wherein the command is transmitted from the network element based at least partly on a comparison of a change in reference timing with a threshold value. The reference timing may be in connection with downlink synchronization timing or uplink transmission timing of the apparatus on the one or more cells.

In step 802, the relaxed measurement is stopped on the one or more cells in response to receiving the command.

FIG. 9 illustrates a flow chart according to an exemplary embodiment. The steps illustrated in FIG. 9 may be performed by an apparatus such as, or comprised in, a network element in a radio access network. For example, the apparatus may correspond to the gNB of FIGS. 3-4.

Referring to FIG. 9, in step 901, a threshold value is indicated to a terminal device in the radio access network, wherein the threshold value is to be compared with a change in reference timing associated with the terminal device for determining whether the terminal device is to apply or stop relaxed measurement on one or more cells of the radio access network. The reference timing may be in connection with downlink synchronization timing or uplink transmission timing of the terminal device on the one or more cells.

FIG. 10 illustrates a flow chart according to an exemplary embodiment. The steps illustrated in FIG. 10 may be performed by an apparatus such as, or comprised in, a network element in a radio access network. For example, the apparatus may correspond to the gNB of FIG. 5.

Referring to FIG. 10, in step 1001, a change in reference timing is compared with a threshold value, wherein the reference timing is associated with a terminal device in the radio access network. The reference timing may be in connection with downlink synchronization timing or uplink transmission timing of the terminal device on the one or more cells.

In step 1002, a command indicating the terminal device to stop relaxed measurement on one or more cells of the radio access network is transmitted to the terminal device based at least partly on the comparison.

The steps and/or blocks described above by means of FIGS. 3-10 are in no absolute chronological order, and some of them may be performed simultaneously or in an order differing from the described one. Other steps and/or blocks may also be executed between them or within them.

A technical advantage provided by some exemplary embodiments is that RRM relaxation may be achieved with higher reliability, decreasing risks of mobility procedure failure. Furthermore, RRM relaxation can be configured more frequently, as misconfiguration (e.g., false stationary detection) can be detected more easily with some exemplary embodiments.

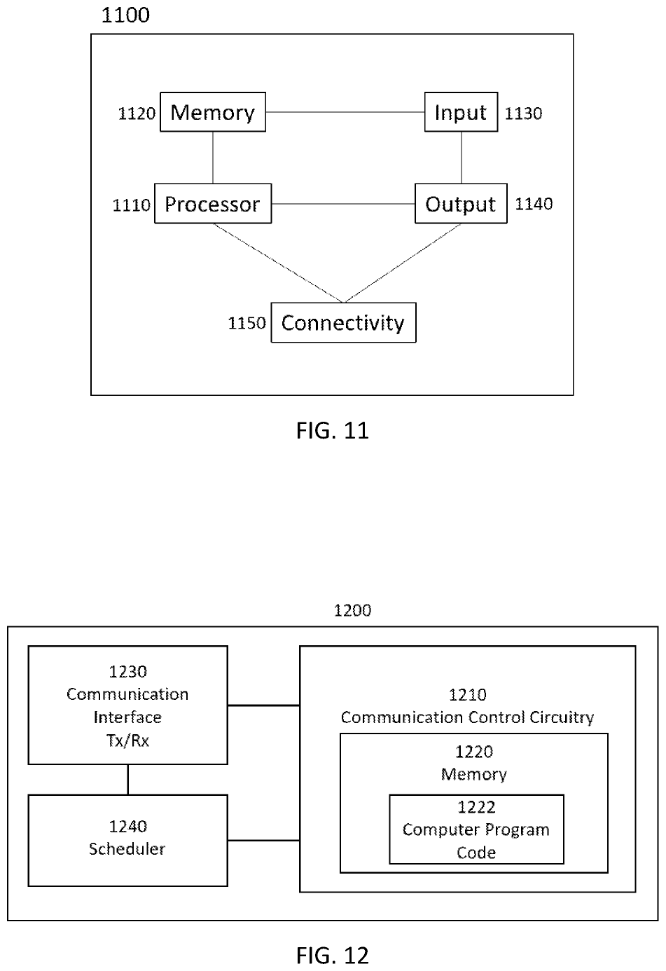

FIG. 11 illustrates an apparatus 1100, which may be an apparatus such as, or comprised in, a terminal device, according to an exemplary embodiment. The terminal device may also be referred to as a UE, user equipment, or reduced capability (RedCap) device herein. The apparatus 1100 comprises a processor 1110. The processor 1110 interprets computer program instructions and processes data. The processor 1110 may comprise one or more programmable processors. The processor 1110 may comprise programmable hardware with embedded firmware and may, alternatively or additionally, comprise one or more application-specific integrated circuits (ASICs).

The processor 1110 is coupled to a memory 1120. The processor is configured to read and write data to and from the memory 1120. The memory 1120 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1120 stores computer readable instructions that are executed by the processor 1110. For example, non-volatile memory stores the computer readable instructions and the processor 1110 executes the instructions using volatile memory for temporary storage of data and/or instructions.

The computer readable instructions may have been pre-stored to the memory 1120 or, alternatively or additionally, they may be received, by the apparatus, via an electromagnetic carrier signal and/or may be copied from a physical entity such as a computer program product. Execution of the computer readable instructions causes the apparatus 1100 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1100 may further comprise, or be connected to, an input unit 1130. The input unit 1130 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1130 may comprise an interface to which external devices may connect to.

The apparatus 1100 may also comprise an output unit 1140. The output unit may comprise or be connected to one or more displays capable of rendering visual content, such as a light emitting diode (LED) display, a liquid crystal display (LCD) and/or a liquid crystal on silicon (LCoS) display. The output unit 1140 may further comprise one or more audio outputs. The one or more audio outputs may be for example loudspeakers.

The apparatus 1100 further comprises a connectivity unit 1150. The connectivity unit 1150 enables wireless connectivity to one or more external devices. The connectivity unit 1150 comprises at least one transmitter and at least one receiver that may be integrated to the apparatus 1100 or that the apparatus 1100 may be connected to. The at least one transmitter comprises at least one transmission antenna, and the at least one receiver comprises at least one receiving antenna. The connectivity unit 1150 may comprise an integrated circuit or a set of integrated circuits that provide the wireless communication capability for the apparatus 1100. Alternatively, the wireless connectivity may be a hardwired application-specific integrated circuit (ASIC). The connectivity unit 1150 may comprise one or more components such as a power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1100 may further comprise various components not illustrated in FIG. 11. The various components may be hardware components and/or software components.

The apparatus 1200 of FIG. 12 illustrates an exemplary embodiment of an apparatus such as, or comprised in, a network element in a radio access network. The network element may also be referred to, for example, as a network node, a RAN node, a NodeB, an LTE evolved NodeB (eNB), a gNB, a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1200 may comprise, for example, a circuitry or a chipset applicable for realizing some of the described exemplary embodiments. The apparatus 1200 may be an electronic device comprising one or more electronic circuitries. The apparatus 1200 may comprise a communication control circuitry 1210 such as at least one processor, and at least one memory 1220 storing instructions that, when executed by the at least one processor, cause the apparatus 1200 to carry out some of the exemplary embodiments described above. Such instructions may, for example, include a computer program code (software) 1222 wherein the at least one memory and the computer program code (software) 1222 are configured, with the at least one processor, to cause the apparatus 1200 to carry out some of the exemplary embodiments described above. Herein computer program code may in turn refer to instructions that cause the apparatus 1200 to perform some of the exemplary embodiments described above. That is, the at least one processor and the at least one memory 1220 storing the instructions may cause said performance of the apparatus.

The processor is coupled to the memory 1220. The processor is configured to read and write data to and from the memory 1220. The memory 1220 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1220 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1220 or, alternatively or additionally, they may be received, by the apparatus, via an electromagnetic carrier signal and/or may be copied from a physical entity such as a computer program product. Execution of the computer readable instructions causes the apparatus 1200 to perform one or more of the functionalities described above.

The memory 1220 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 1200 may further comprise a communication interface 1230 comprising hardware and/or software for realizing communication connectivity according to one or more communication protocols. The communication interface 1230 comprises at least one transmitter (Tx) and at least one receiver (Rx) that may be integrated to the apparatus 1200 or that the apparatus 1200 may be connected to. The communication interface 1230 provides the apparatus with radio communication capabilities to communicate in the cellular communication system. The communication interface may, for example, provide a radio interface to terminal devices. The apparatus 1200 may further comprise another interface towards a core network such as the network coordinator apparatus and/or to the access nodes of the cellular communication system. The apparatus 1200 may further comprise a scheduler 1240 that is configured to allocate resources. The scheduler 1240 may be configured along with the communication control circuitry 1210 or it may be separately configured.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus in a radio access network, the apparatus comprising at least one processor, and at least one memory including computer program code, wherein the at least one memory and the computer program code are configured, with the at least one processor, to cause the apparatus to:
compare a change in reference timing with a threshold value; and
apply or stop relaxed measurement on one or more cells of the radio access network based at least partly on the comparison.

2. The apparatus according to claim 1, wherein the apparatus is further caused to stop the relaxed measurement on the one or more cells, if the change in the reference timing exceeds the threshold value.

3. The apparatus according to claim 1, wherein the apparatus is further caused to initiate or apply the relaxed measurement on the one or more cells, if the change in the reference timing is less than or equal to the threshold value.

4. The apparatus according to claim 1, wherein the apparatus is further caused to:
increment a value of a parameter based on one or more adjustments of the reference timing, wherein the one or more adjustments correspond to the change in the reference timing; and
compare the incremented value of the parameter with the threshold value upon expiration of a timer.

5. The apparatus according to claim 4, wherein the apparatus is further caused to:
initialize the parameter by setting the value for the parameter; and
start the timer upon initializing the parameter.

6. The apparatus according to claim 5, wherein the initialization of the parameter is triggered by at least one of: reception of the threshold value from a network element in the radio access network, initiation of the relaxed measurement on the one or more cells, stopping of the relaxed measurement on the one or more cells, and/or changing of a beam.

7. The apparatus according to claim 4, wherein the apparatus is further caused to:
receive, from the network element in the radio access network, the threshold value and a time value for the timer, wherein the time value indicates a time interval for performing the comparison;
wherein the timer expires upon reaching the time value.

8. The apparatus according to claim 7, wherein the threshold value and the time value for the timer are received in system information or in a radio resource control reconfiguration message.

9. The apparatus according to claim 4, wherein the apparatus is further caused to:
perform the one or more adjustments of the reference timing based on one or more received timing advance commands or one or more received synchronization signals.

10. An apparatus in a radio access network, the apparatus comprising at least one processor, and at least one memory including computer program code, wherein the at least one memory and the computer program code are configured, with the at least one processor, to cause the apparatus to:
receive, from a network element in the radio access network, a command for stopping relaxed measurement on one or more cells of the radio access network, wherein the command is transmitted from the network element based at least partly on a comparison of a change in reference timing with a threshold value; and
stop the relaxed measurement on the one or more cells in response to receiving the command.

11. The apparatus according to claim 10, wherein the reference timing is in connection with downlink synchronization timing or uplink transmission timing on the one or more cells.

12. The apparatus according to claim 10, wherein the apparatus is configured to operate in frequency range 2.

13. The apparatus according to claim 10, wherein the apparatus comprises, or is comprised in, a terminal device.

14. The apparatus according to claim 13, wherein the terminal device is a reduced capability device.

15. An apparatus in a radio access network, the apparatus comprising at least one processor, and at least one memory including computer program code, wherein the at least one memory and the computer program code are configured, with the at least one processor, to cause the apparatus to:
indicate, to a terminal device in the radio access network, a threshold value, wherein the threshold value is to be compared with a change in reference timing associated with the terminal device for determining whether the terminal device is to apply or stop relaxed measurement on one or more cells of the radio access network.

16. The apparatus according to claim 15, wherein the apparatus is further caused to:
indicate, to the terminal device, a time value for a timer, wherein the time value indicates a time interval for performing the comparison.

17. The apparatus according to claim 16, wherein the threshold value and the time value are indicated to the terminal device in system information or in a radio resource control reconfiguration message.

18. An apparatus in a radio access network, the apparatus comprising at least one processor, and at least one memory including computer program code, wherein the at least one memory and the computer program code are configured, with the at least one processor, to cause the apparatus to:
compare a change in reference timing with a threshold value, wherein the reference timing is associated with a terminal device in the radio access network; and
transmit, to the terminal device, based at least partly on the comparison, a command indicating the terminal device to stop relaxed measurement on one or more cells of the radio access network.

19. The apparatus according to claim 18, wherein the command is transmitted to the terminal device, if the change in the reference timing exceeds the threshold value.

20. The apparatus according to claim 18, wherein the reference timing is in connection with downlink synchronization timing or uplink transmission timing on the one or more cells.

21.-38. (canceled)
